(19) United States
(12) Patent Application Publication
(10) Pub. No.: US 2002/0039975 A1
(43) Pub. Date: Apr. 4, 2002

(54) Simplified process for cleaning and disinfecting contact lenses with a single solution

(76) Inventors: Ralph P. Stone, Fort Worth, TX (US); Masood A. Chowhan, Arlington, TX (US); Ruth Ann Rosenthal, Alvarado, TX (US)

Correspondence Address: ALCON RESEARCH, LTD., R&D COUNSEL, Q-148, 6201 SOUTH FREEWAY, FORT WORTH, TX, 76134-2099, US

(21) Appl. No.: 09/885,637

(22) Filed: Jun. 20, 2001

Related U.S. Application Data
(60) Provisional application No. 60/221,797, filed on Jul. 31, 2000.

(51) Int. Cl. C11D 1/00

(52) U.S. Cl. 510/112

(57) ABSTRACT

An improved, simplified process for cleaning and disinfecting contact lenses is described. The process employs a multi-purpose solution containing a non-oxidative antimicrobial agents, and does not include or require rubbing of the lenses.

### CLAIM OF PRIORITY

Pursuant to 35 U.S.C. § 120, Applicants hereby claim priority based on Provisional Application Ser. No. 60/221,797.

### BACKGROUND OF THE INVENTION

The present invention is directed to processes for cleaning and disinfecting contact lenses. More particularly, the invention is directed to an improved, simplified process for cleaning and disinfecting contact lenses that does not require a rubbing step.

Over the past several years, there has been an effort to simplify the procedures required for cleaning and disinfecting contact lenses. These simplication efforts have led to the development and wide spread use of products generally referred to as “multi-purpose solutions.”

Prior to the advent of multi-purpose solutions, the “regimens” for cleaning and disinfecting contact lenses required the use of several different products and were fairly complicated. For example, a typical multi-product regimen may have included: (1) a daily cleaner product, which typically contained a surfactant and possibly other cleaning agents (e.g., microscopic polymeric beads); (2) a soaking solution, which was generally used to disinfect the contact lenses; (3) a saline solution, which was generally used to rinse the lenses following use of the daily cleaner product or at various other stages of the cleaning and disinfecting regimen; (4) an enzymatic cleaner product for removing protein deposits, either daily or weekly; and (5) rewetting drops and/or comfort drops, which were generally used to rehydrate or moisten the lenses as needed.

The large number of products and procedures required in prior art multi-product regimens caused the regimens to be both expensive and inconvenient. The multi-purpose solutions addressed these problems by reducing the number of products required and simplifying the cleaning and disinfecting procedures. However, in order to meet applicable cleaning and disinfection standards, it was necessary to use the multi-purpose solutions in accordance with multi-step processes.

The prior art processes for cleaning and disinfecting contact lenses with multi-purpose solutions involved an initial rubbing and rinsing of the lenses following removal of the lenses from the eyes. The rubbing and rinsing step was performed in place of treatment with a separate daily cleaner product. The rubbing step contributed significantly to both cleaning and disinfection of the lenses. In fact, the studies reported in the following articles indicate that the initial rubbing and rinsing step represents a major part of the overall cleaning and disinfecting regimen, particularly for multi-purpose solutions having relatively low levels of antimicrobial activity: Houlsby, et al., “Microbiological Evaluation of Soft Contact Lenses Disinfecting Solutions”, Journal of the American Optometric Association, vol. 55, pp. 205-211 (1984); Shih, et al., “The Microbiological Benefit of Cleaning and Rinsing Contact Lenses” International Contact Lens Clinic, vol. 12, pages 235-242 (1985); and Shih, et al., “Disinfecting Activities of Non-peroxide Soft Contact Lens Cold Disinfection Solutions”, CLAO Journal, vol. 17, pp. 165-168 (1991). The 1991 article by Shih, et al. states:

“For these newer chemical disinfection systems, diligent cleaning and rinsing of the soft contact lenses are the most important steps in the patient care regimen.”

The studies conducted by Houlsby, et al. and Shih, et al. (1985) demonstrate that the initial cleaning and rinsing step plays a very substantial role in achieving disinfection of contact lenses. Both studies found that this step reduced the number of microorganisms present on the lens by more than 99.9%. Thus, prior to the present invention, there was a well-founded belief that the initial rubbing and rinsing of lenses treated with multi-purpose solutions was an integral and necessary part of the overall cleaning and disinfection regimen.

The above— discussed multi-purpose solutions provided a significant advancement in convenience for contact lens wearers, However, as contact lens wear has continued to shift toward the use of frequent replacement lenses (i.e., lenses that are typically worn for no more than a few weeks), a need for further simplication of the cleaning and disinfecting regimens has become apparent. One way to simplify the process would be to eliminate the initial rubbing and rinsing step entirely. The elimination of this step would mean that the lenses could be removed from the eyes and placed directly in the multi-purpose solution to be disinfected. Elimination of the rubbing portion of the initial rubbing and rinsing step would be particularly desirable.

The desire to eliminate the rubbing step is based in part on the fact that soft contact lenses can be easily torn when removed from the eye and rubbed. This requires replacement of the torn lens and represents a major inconvenience and expense for the contact lens wearer. Moreover, elimination of the rubbing step would result in a more convenient regimen for cleaning and disinfecting the lenses. With the elimination of this step, wearers of contact lenses could clean and disinfect their lenses by merely removing the lenses from the eye, rinsing the lenses briefly, and then soaking the lenses for a few hours or more.

Elimination of the rubbing and rinsing step may, at first, seem to be a simple modification of the existing regimens. However, in reality, the elimination of this step is not a simple matter, because the prior regimens for multi-purpose solutions have depended heavily on this step to achieve both cleaning and disinfection. As discussed above, the initial rubbing and rinsing of the lens has been shown to play a major role relative to achieving disinfection of the lens. This step has also been shown to play a major role relative to achieving cleaning. For example, it has been shown that the rubbing step contributes to both cleaning and disinfection of contact lenses treated with a prior multi-purpose solution marketed by Alcon Laboratories, Inc. under the name “OPTI-FREE® Rinsing, Disinfecting and Storage Solution” (hereinafter referred to as “Opti-Free® Solution”). These findings are discussed in the following publication: Chowhan, et al., “Opti-Free® as an All-purpose Solution”, Contactologia, 15E, pages 190-195 (1993). The authors of this article stated the following conclusion based on their studies:

“When Opti-Free® is used as a daily cleaner, removal of contaminating microorganisms and protein (lysozyme) deposits is considered to be achieved by the mechanical action of digital rubbing together with the solvent action of water in the aqueous formation . . . and the cleaning action of citrates.” The reference to the use of Opti-Free® Solution as a “daily cleaner” in this statement means that the Opti-Free® brand multi-purpose solution was used to perform initial rinsing and cleaning steps, instead of a separate daily cleaner product. Thus, the authors in effect concluded that when the daily cleaner products of prior cleaning and disinfecting regimens are replaced with multi-purpose solutions such as the Opti-Free® Solution, the rubbing and rinsing step is an intregal and necessary part of the overall cleaning and disinfecting process.

In the United States, the cleaning and disinfecting efficacy of multi-purpose solutions is subject to the regulations of the United States Food and Drug Administration (“FDA”). The efficacy of prior multi-purpose solutions has generally been established based on the overall cleaning and disinfection achieved with the cleaning and disinfecting regimen, including the rubbing and rinsing step. Elimination of this step would therefore raise significant issues regarding the ability to obtain regulatory approval for the use of multi-purpose solutions in processes that do not include this step.

The possible elimination of the rubbing step of regimens for multi-purpose solutions has been discussed in prior patent publications, including the following:

WO 91/17469;

WO 95/18204;

WO 97/00931;

WO 97/26963;

WO 97/43373;

WO 98/20738;

WO 99/24541;

WO 99/24542;

WO 99/24543; and

WO 99/43363.

The cleaning and disinfecting systems described in these publications involve the use of various types of solutions. However, prior to the present invention, no multi-purpose solution has been approved for marketing by the FDA without a rubbing step.

### SUMMARY OF THE INVENTION

The present invention is based on the surprising finding that the rubbing step of prior procedures for cleaning and disinfecting contact lenses with multi-purpose solutions can be eliminated without compromising the efficacy of the solutions. This discovery has been made based on both laboratory and clinical testing.

The testing has established that the multi-purpose solution of the present invention is capable of removing protein deposits and other debris and from contact lenses during the soaking step of the cleaning and disinfecting regimen. This is referred to as “passive” cleaning, that is, cleaning achieved without actively rubbing or otherwise manipulating the lenses. The testing has also established that the cleanliness of human worn contact lenses treated in accordance with the process of the present invention is comparable to or better than the cleanliness achieved with a leading commercial multi-purpose solution when used in a prior art process that includes a rubbing step.

The testing referred to above has also established that the process of the present invention is capable of effectively disinfecting contact lenses without the rubbing step of prior art processes. As indicated above, the rubbing step in prior art processes for cleaning and disinfecting contact lenses has been shown to contribute to the removal of protein deposits and other organic matter from the lenses. The elimination of this step therefore increases the likelihood that proteins and other organic matter will be present on a lens when it is soaked in a multi-purpose solution to achieve disinfection.

It is known that organic soils frequently have a negative impact on the antimicrobial activity of disinfecting agents. This principle is discussed in the following article: Whitmore, et al., “Analysis and Optimization of the Quantitative Organic Soil Neutralization Test for Disinfectants”, Journal of the AOAC, vol. 59, pp. 1344-1351 (1976). Thus, elimination of the rubbing step of prior art processes for cleaning and disinfecting contact lenses with multi-purpose solutions is potentially significant not only with respect to achieving adequate cleaning of the lens, but also with respect to achieving adequate disinfection.

The present invention is based in part on the surprising finding that a new treatment process, wherein the rubbing portion of the initial rubbing and rinsing step utilized in prior art processes is eliminated, is able to both clean and disinfect contact lenses effectively.

### DETAILED DESCRIPTION OF THE INVENTION

The improved, simplified process of the present invention includes the following steps:

(a) rinsing each side of a contact lens for a few seconds with a multi-purpose solution;

(b) soaking the lens in the multi-purpose solution for a time sufficient to clean and disinfect the lens;

(c) removing the lens from the multi-purpose solution; and

(d) rinsing each side of the lens for a few seconds with the multi-purpose solution.

The process of the present invention does not include a rubbing step or any comparable steps wherein the surface of the lens is abraded. The present inventors have found that this process is effective in cleaning and disinfecting contact lenses, when utilized in conjunction with a particular type of multi-purpose solution, as described herein.

The process of the present invention employs Opti-Free® Express® Multi-Purpose Disinfecting Solution (hereinafter referred to as “Opti-Free® Express® Solution”) and other multi-purpose solutions of the type described in the following patent publications: (1) International Publication Number WO 98/25649 and corresponding U.S. Patent Application Ser. No. 09/308,456; and (2) U.S. Pat. Nos. 5,393,491; 5,573,726; and 5,631,005. The entire contents of the foregoing patent publication are hereby incorporated in the present specification by reference.

These patent publications describe multi-purpose solutions that are similar to the prior Opti-Free® Rinsing, Disinfection and Storage Solution (“Opti-Free® Solution”) in some respects. Specifically, the solutions are similar in that, as with the Opti-Free® Solution, two of the principal ingredients of the Opti-Free® Express® Solution are citrate and the antimicrobial agent known as polyquaternium -1. Prior to the present invention, the Opti-Free® Solution was utilized in essentially the same manner as the Opti-Free(® Express® Solution. Both solutions required a rubbing step. The present invention is based on the surprising discovery that this step can be eliminated without compromising the cleaning and disinfecting efficacy of the Opti-Free® Express® Solution and related solutions described herein.

The solutions utilized in the process of the present invention are based on a unique combination of three groups of components:

Cleaning System

The principal component of the cleaning system is a complexing agent that facilitates the removal of protein deposits from contact lenses. The preferred complexing agent is citrate. However, other complexing agents may also be utilized. The use of citrate and other complexing agents to remove protein deposits from contact lenses described in U.S. Pat. No. 5,370,744; the entire contents of the ′744 patent are hereby incorporated in the present specification by reference.

The cleaning system preferably contains one or more surfactants. The preferred surfactants are nonionic surfactants, such as Tetronic 1304, which is available from BASF Corporation.

The cleaning system preferably also contains one or more low molecular weight amino alcohols. The preferred low molecular weight amino alcohols are described in U.S. Patent Application Ser. No. 09/308,456 cited above. The preferred alcohol is 2-amino-2-methyl-1-propanol, which is also referred to as “AMP”. The most preferred alcohol is AMP-95, which consists of 95% pure AMP and 5% water. It is commercially available from Angus Chemical Company (Buffalo Grove, Ill.).

Comfort System

The principal ingredients of the comfort system are osmolality-adjusting agents, which may include both ionic salts, such as sodium chloride, or nonionic polyhydric alcohols, such as sorbitol, mannitol and propylene glycol.

The comfort system preferably also includes boric acid and/or a borate salt, and a low molecular weight amino alcohol, such as AMP-95.

These components function to provide the solution with an osmolality and pH suitable for products utilized in the treatment of contact lenses, particularly soft contact lenses. The osmolality will generally range from somewhat hypotonic to isotonic, and the pH will generally range from neutral to slightly alkaline. Although the primary function of the components is to provide osmolality adjustment or buffering of the solution, the components also serve other important functions. Namely, the boric acid/borate combines with polyhydric alcohols such as sorbitol and mannitol to form a complex that enhances the antimicrobial activity of the solution. The use of such complexes in contact lens care solutions is described in U.S. Pat. No. 5,811,466; the entire contents of the ′466 patent are hereby incorporated in the present specification by reference.

Similarly, the low molecular weight amino alcohols (e.g., AMP-95) not only help buffer the solution, but also enhance the antimicrobial activity of the solution, as described in U.S. Patent Application Ser. No. 09/308,456.

Disinfecting System

The principal ingredient of the disinfecting system consists of one or more ophthalmically acceptable, non-oxidative antimicrobial agents. The most preferred antimicrobial agents are polymeric quaternary ammonium compounds, such as polyquaterium -1 or polymeric biguanides, such as polyhexamethylene biguanide. The use of polyquaternium-1 in contact lens disinfecting solutions is described in U.S. Pat. Nos. 4,525,346 and 5,037,647. The use of polymeric biguanides in contact lens disinfecting solutions is described in U.S. Pat. Nos. 4,758,595 and 4,836,986. The entire contents of all four of these patents are hereby incorporated in the present specification by reference.

The disinfecting system preferably also contains one or more amidoamines of the type described in U.S. Pat. Nos. 5,393,491; 5,573,726; and 5,631,005. The most preferred amidoamine is myristamidopropyldimethyl— amine, which is also referred to as “MAPDA”. The amidoamines function to enhance the antimicrobial activity of the multi-purpose solutions, particularly with respect to fungi.

The most preferred multi-purpose solution is the Opti-Free® Express® Solution referred to above. The formula of this product is provided in Example 1, below:

| Ingredient | % (w/v) |
|---|---|
| Polyquaternium-1 | 0.001 |
| AMP-95 | 0.45% |
| MAPDA | 0.0005% |
| Boric acid | 0.6 |
| Sorbitol | 1.2 |
| Sodium chloride | 0.1 |
| Sodium citrate | 0.65 |
| Tetronic 1304 | 0.05 |
| Disodium Edetate | 0.05 |
| Sodium hydroxide | Q.S. pH 7.8 |
| Hydrochloric acid | Q.S. pH 7.8 |
| Purified water | Q.S. 100 |

The above formulation has been tested to evaluate its ability to remove protein deposits from contact lenses when utilized in a process that does not include a rubbing step. These tests have demonstrated that it is possible to eliminate this step and still achieve both cleaning and disinfection. This finding is surprising, particularly in view of prior testing of the same solution and other solutions. Both sets of testing are discussed below.

In three prior tests, Opti-Free® Express® Solution was compared to a leading multi-purpose solution, ReNu® Multi-Plus® Multi-Purpose Solution with Hydranate® Protein Remover (referred to hereinafter as “ReNu® Multi-Plus®”). An initial test, described in Example 2, below, measured the ability of the Opti-Free® Express® and ReNu® Multi-Plus® solutions to remove protein deposits formed on lenses in the laboratory by means of passive cleaning (i.e., soaking soiled lenses in the solutions, without any prior rubbing of the lenses). A second test, described in Example 3, below, evaluated the ability of these same solutions to remove protein deposits formed on human worn contact lenses. In both of these tests, the Opti-Free® Express® formulation achieved a somewhat greater degree of protein removal from the lenses than the ReNu® Multi-Plus® Solution.

In a third test, described in Example 4, below, human worn lenses were treated in accordance with the prescribed cleaning and disinfecting regimens for Opti-Free® Expresse and ReNu® Multi-Plus(® Solutions. The regimens for both products included a rubbing step. The Opti-Free® Express® solution also demonstrated a greater degree of protein removal than the ReNu® Multi-Plus® solution in this test. However, the difference between the two solutions in this test was more remarkable than in the first two tests (i.e., the tests described in Examples 2 and 3), wherein no rubbing step was involved. A comparison of these three prior tests (i.e., Examples 2, 3 and 4) reasonably leads to the conclusion that the superior cleaning effect of the Opti-Free® Express® Solution is due at least in part to the rubbing step.

With the foregoing tests in mind, the present inventors reasonably expected that elimination of the rubbing step from the prior cleaning and disinfecting regimen for Opti-Free® Express® Solution would significantly diminish the superior cleaning effect of this solution, relative to the ReNu® Multi-Plus® Solution. However, as a result of a further test described in Example 5, below, the inventors discovered that elimination of the rubbing step did not diminish the superior cleaning effect of the Opti-Free® Express® Solution. Based on their prior experience with this solution and related solutions, this finding was quite unexpected.

The present inventors have also discovered that the disinfection capacity of the Opti-Free® Express® Solution is not compromised as a result of the increased organic load that may be present on contact lenses due to the omission of the rubbing step. This finding, which could not have been predicted in view of the prior art teachings regarding the negative impact of organic matter on antimicrobial activity, is described in Example 6, below.

### EXAMPLE 2

A laboratory study was conducted to evaluate the ability of several commercial multi-purpose solutions to remove protein deposits from Group IV contact lenses. In this study, the protein deposits were formed in the laboratory. The testing procedures and results were as follows:

Procedure

In order to form protein deposits on the lenses, each lens was first placed in a glass vial containing 5-milliliter (“mL”) of the following lysozyme solution:

| Component Name | Concentration (% w/v) |
|---|---|
| Lysozyme | 0.15 |
| Sodium Chloride, USP | 0.9 |
| Monobasic Sodium Phosphate | 0.1311 |
| (Monohydrate), USP | |
| Dibasic Sodium Phosphate | 0.5749 |
| (Anhydrous), USP | |
| Sodium Hydroxide, NF | Adjust pH to 7.4^{a} |
| Hydrochloric Acid, NF | Adjust pH to 7.4^{a} |
| Purified Water, USP | QS to 100 |

^{a}pH adjusted to 7.4 ± 0.1

The vials were then covered with rubber stoppers, and the lenses were allowed to soak in the lysozyme solution for 48 hours in order to form protein deposits on the lenses.

The lenses were then removed from the protein deposition solution and cut in half with a scalpel. One half of each lens was then placed in 3mL of a specified multi-purpose solution, and then other half of the same lens was placed in the same volume of a different multi-purpose solution. The lens halves were soaked in the respective multi-purpose solutions for at least 48 hours, and then were removed from the solutions.

Following removal of the lens halves, the solutions were assayed to determine the amount of lysozyme present in the solutions. The amount of lysozyme present in the solutions represented the amount of protein, i.e., lysozyme, removed from the lens halves by the multi-purpose solutions. The procedures utilized in this analysis are described in the following article: Keith, et al., “A novel procedure for the extraction of protein deposits from soft hydrophilic contact lenses for analysis”, Current Eye Research, vol. 16, pp. 503-510, (1997).

Five lenses were treated in the above-described manner to directly compare the cleaning ability of the Opti-Free® Express® Solution to that of the ReNu® Multi-Plus® Solution. Five lens halves were treated with each solution, and the amount of protein (lysozyme) removed from each of the lens halves was measured in micrograms. The results were as follows:

| Product Name | Lens #1 | Lens #2 | Lens #3 | Lens #4 | Lens #5 |
|---|---|---|---|---|---|
| Opti-Free ® Express ® | 184.40* | 167.50 | 153.75 | 130.35 | 0.00 |
| ReNu ® Multi-Plus ® | 122.66 | 119.94 | 143.58 | 215.67 | 147.47 |

The average amount of protein removed with the two solutions in this direct comparison was as follows:

| | |
|---|---|
| Opti-Free ® Express ® | 127.20 ± 73.81 |
| ReNu ® Multi-Plus ® | 149.82 ± 38.77 |

(The results are expressed as micrograms of lysozyme removed per lens half, mean value +/−standard deviation.) The differences in these values were not statistically significant.

In the same study, the Opti-Free® Express® and ReNu® Multi-Plus® Solutions were also directly compared to other multi-purpose solutions. A total of five additional lens halves were treated with the Opti-Free® Express® Solution, and a total of 20 additional lens halves were treated with the ReNu® Multi-Plus® Solution. The average amounts of protein removed with these solutions, relative to the entire study, are as follows:

| | |
|---|---|
| Opti-Free ® Express ® | 188.7* |
| (n = 10) | |
| ReNu ® Multi-Plus ® | 118.2* |
| (n = 25) | |

Expressed as micrograms of lysozyme removed per lens half, mean value. These overall results indicate that the Opti-Free® Express® Solution is somewhat more effective than the ReNu® Multi-Plus® Solution relative to passive cleaning.

### EXAMPLE 3

A second laboratory study was conducted to evaluate the ability of several commercial multi-purpose solutions to remove protein deposits from human-worn contact lenses. As in the study described in Example 2, Group IV contact lenses were utilized. The testing procedures and results were as follows.

Procedure

Group IV human-worn lenses were collected. Each lens was cut in half with a scalpel. One half of each lens was then placed in 3 mL of a specified multi-purpose solution, and the other half of the same lens was placed in 3 mL of a different multi-purpose solution. The lens halves were soaked in the respective multi-purpose solutions for at least 48 hours, and then were removed from the solutions.

Following removal of the lens halves, the solutions were assayed to determine the amount of lysozyme present using an HPLC method. The assay procedures utilized were the same as those cited in Example 2 above. As in the study described in Example 2, the lysozyme present in the solution represented the amount of protein, i.e., lysozyme, removed from the lens halves by the multi-purpose solutions.

Five human-worn contact lenses were treated in the above-described manner to directly compare the cleaning ability of the OPTI-FREE® Express® Solution to that of the ReNu® Multi-Plus® Solution. The amount of protein (lysozyme) removed from each of the lens halves was measured in micrograms. The results, expressed as micrograms of lysozyme removed per lens, were as follows:

| Product Name | Lens #1 | Lens #2 | Lens #3 | Lens #4 | Lens #5 |
|---|---|---|---|---|---|
| Opti-Free ® Express ® | 531.73 | 600.08 | 572.85 | 578.62 | 477.89 |
| ReNu ® Multi-Plus ® | 389.49 | 398.31 | 468.89 | 432.36 | 415.63 |

The average amount of protein removed with the two solutions in this direct comparison was as follows:

| | |
|---|---|
| OPTI-FREE ® Express ® | 552.23 ± 48.37 |
| ReNu ® Multi-Plus ® | 420.94 ± 31.46 |

(The results are expressed as micrograms of lysozyme removed per lens; mean value ±standard deviation). The differences in these values were statistically significant. As in Example 2, above, the results indicate that the Opti-Free® Express® Solution is somewhat more effective than the ReNu® Multi-Plus® Solution relative to passive cleaning.

### EXAMPLE 4

A further study was conducted to compare Opti-Free® Express® Solution and ReNu® Multi-Plus® Solution, relative to the ability of these solutions to prevent a build-up of protein deposits on human worn, Group IV contact lenses.

The participants in the study treated their lenses in accordance with the labeled instructions for use on Opti-Free® Express® Solution and ReNu® Multi-Plus® Solution. The treatment regimens for both solutions included a rubbing step, prior to soaking the lenses in the respective solutions.

The study was initiated with new Acuvue® brand lenses. The lenses were worn for 30 days, and were cleaned and disinfected on a daily basis, in accordance with the following instructions:

Instructions for Use of Opti-Free® Express® Solution

Step I— Daily Cleaning

Remove one lens and place it in the palm of your hand.

Apply 2 drops of the solution to each lens surface.

Clean each side of the lens by rubbing gently in the palm of your hand.

Step II— Rinsing

Thoroughly rinse both surfaces of the lens with the solution.

Step III— Disinfecting/Storing

Fill lens case with fresh solution.

Place clean lens in lens case.

Repeat the cleaning, rinsing and disinfecting/storing steps with the other lens.

Leave lenses in the closed storage case containing the solution overnight (a minimum of 6 hours).

Step IV— Lens Reinsertion

Remove lenses from lens case and rinse with the solution.

Instructions for Use of ReNu® Multi-Plus® Solution

Step I— Daily Cleaning

Remove one lens and place it in the palm of your hand.

Place at least 3 drops of the solution onto each side of contact lens.

Rub the lens for 20 seconds.

Step II— Rinsing

Rinse the lens thoroughly with the solution. Step III— Disinfecting/Storng

Place the clean lens in lens case and fill with fresh solution.

Repeat the cleaning, rinsing and disinfecting/storing steps with the other lens.

Soak lenses in the closed storage case for at least 4 hours.

Step IV— Lens Reinsertion

Remove the lenses from the lens case and rinse with the solution.

On the 30^{th} day of the study, the lenses were cleaned and disinfected, and then were subjected to a chemical analysis to determine the amount of protein present on each lens. The procedures utilized to make this determination are described in the article by Keith, et al., cited in Example 2, above. The results of the analysis were as follows:

| | Opti-Free ® Express ® | ReNu ® Multi-Plus ® |
|---|---|---|
| Average Residual | 545.71 | 984.77 |
| Lysozyme | | |
| (micrograms per lens) | | |
| Standard Deviation | 187.34 | 248.70 |
| Number of Lenses | 89 (n) | 88 (n) |

These results showed a much more dramatic difference between the two solutions than the prior laboratory studies described in Example 2 and 3, above.

### EXAMPLE 5

A second study of human worn lenses was conducted to evaluate the ability of the Opti-Free® Express® Solution to clean Group IV contact lenses if the rubbing step of the treatment regimen was eliminated. The cleaning ability of the Opti-Free® Express® Solution was again compared to that of the ReNu® Multi-Plus® Solution. The study was initiated with new Surevue® brand lenses. The lenses were worn for 30 days, and were cleaned and disinfected on a daily basis, in accordance with the following instructions:

Instructions for Use of Opti-Free® Express® Solution

Step I— Rinsing

Remove one lens. Rinse both surfaces of the lens for 5 seconds with the solution.

Step II— Disinfecting/Storing

Fill the lens storage case with enough fresh solution to cover the lens.

Place lens in the storage case and check to see that it is completely submerged.

Repeat the rinsing and storing steps with the other lens.

Close the storage case tightly and leave lenses in the case overnight or for at least 6 hours.

Step III— Lens Reinsertion

Remove lenses from the lens case and rinse both surfaces of each lens for 5 seconds with the solution. Lenses can now be reinserted.

Instructions for Use of ReNu® Multi-Plus® Solution

Step I— Cleaning

Removing one lens and place it in the palm of your hand.

Place at least 3 drops of the solution on each side of contact lens and rub for 20 seconds.

Step II— Rinsing

Remove surface debris by rinsing thoroughly with the solution.

Step III— Disinfecting/Storing

Place cleaned contact lens in lens case and fill with fresh solution.

Repeat the cleaning, rinsing and storing steps with the other lens.

Soak lenses in the closed storage case containing the solution for at least 6 hours.

Step IV— Lens Reinsertion

Remove the lenses from the lens case.

Rinse lenses with the solution to remove any remaining debris. Lenses can now be reinserted.

On the 30^{th} day of the study, the lenses were cleaned and disinfected, and then were analyzed for protein deposits as described in Example 4, above. The results of the analysis were as follows:

| | Opti-Free ® Express ® | ReNu ® Multi-Plus ® |
|---|---|---|
| Average Residual | 604.6 | 1078.2 |
| Lysozyme | | |
| (micrograms per lens) | | |
| Standard Deviation | 208.0 | 284.4 |
| Number of Lenses | 34 | 34 |

As in the study described in Example 4, the lenses treated with the Opti-Free® Express® Solution exhibited significantly less protein deposit formation than the lenses treated with the ReNu® Multi-Plus® Solution, despite the fact that the treatment regimen used with the latter solution included a rubbing step.

The studies described in Examples 2 and 3 above indicated that the two solutions were roughly comparable, relative to the ability to remove protein deposits from the contact lenses by means of soaking (i.e., passive cleaning). However, the study described in Example 4 indicated that when these same two solutions were used in regimens that include rubbing steps, the Opti-Free® Express® Solution was significantly more effective than the ReNu® Multi-Plus® Solution relative to the removal and prevention of protein deposits on human worn lenses. Thus, the study of Example 4, together with the studies of Examples 2 and 3, lead to the conclusion that the rubbing step of the regimen used with the Opti-Free® Express® Solution in Example 4 is contributing significantly to the cleaning effect of this solution.

Based on the results of the study described in Example 5, the inventors have unexpectedly discovered that the rubbing step of the prior Opti-Free® Express® treatment regimen can be eliminated without diminishing the overall cleaning effect of the solution.

The solution of Example 1 (i.e., OPTI-FREE® Express® Solution) has also been tested to assess the impact of an increased organic load on the ability of the solution to disinfect contact lenses. As discussed above, it was feared that elimination of the rubbing step would lead to an increased amount of proteins and other organic matter on the lenses when the lenses were placed in the solution to achieve disinfection. In view of this concern, the Opti-Free® Express® Solution was tested in the presence of organic soils, so as to assess the potential impact of the “no rub” process described herein on disinfection. This testing is described in the following example:

### EXAMPLE 6

A study was conducted to evaluate the antimicrobial activity of Opti-Free® Express® Solution in the presence of organic soil using a procedure based on the FDA Premarket Notification (510 (k)) Guidance Document for Contact Lens Care Products (May, 1997, draft) and the ISO/DIS 14729 Guidelines (January, 1999, draft). The testing procedures were as follows:

Preparation of Microbial Challenge (Inoculum)

Bacterial and Yeast Cultures

Cultures of S. marcescens, P. aeruginosa and S. aureus were grown on slants of soybean-casein digest agar (SCDA) at 30°-35° C. for 18-24 hours. C. albicans was grown on Sabouraud dextrose agar (SDA) slants at 30°-35° C. for 18-24 hours. Cultures were harvested by washing the surfaces of the slants with sterile peptone water (0.1%). Each suspension was adjusted with sterile peptone to obtain an optical density that produced suspensions of approximately 1.0×10⁷ −1.0×10⁸ CFU/mL using a spectrophotometer set at a wavelength of 525 nm. The actual concentration of CFU/mL for each suspension was determined by the plate count method at the time of the test. Fresh bacterial and yeast suspensions were prepared and used on the day of preparation.

Mold Culture

Cultures of F. solani were grown on potato dextrose agar (PDA) for 10-14 days at 20°-25° C. The spores were harvested by aseptically removing mycelial mats, placing them in a sterile flask containing PBST and sterile glass beads, and shaking vigorously for approximately 10 minutes. The fungal suspension was filtered through sterile gauze and concentrated by centrifugation for 40 minutes at 3000 rpm and 20° C. The suspension was adjusted with PBST to approximately 1.0×10⁷−1.0×10⁸ CFU/mL using a spectrophotometer set at a wavelength of 525nm. Next, the spore suspension was centrifuged and resuspended in peptone prior to testing. The spore suspension preparation was stored under refrigeration up to 7 days.

Test Procedure

A 10 mL volume of the test solution was inoculated with a 0.1 mL aliquot of the 1.0×10⁷ -1.0×10⁸ CFU/mL organism suspension to provide a final count of 1.0 x 10⁵ -1.0 x 106 CFU/mL. A volume of 0, 0.02 or 0.04 mL of organic soil was added to the test solution immediately after inoculation. Each lot of product was tested with a separate inoculum for each challenge organism. A 1.0 mL aliquot of the inoculated test solution was taken to determinate the viable count at specified time intervals, including the specified disinfection time of 6 hours. Serial dilutions were prepared in DE Neutralizing media. Duplicate pour plates were prepared using SCDA with 0.5% Tween 80 and 0.07% Asolectin. Bacterial and yeast plates were incubated for 2-4 days at 30°-35° C. Mold plates were incubated at 20°-25° C. for 3-7 days. The number of CFU was determined and recorded and the microbial reduction at the specified time points was calculated.

Inoculum Control

Inoculum controls were made by dispensing an identical aliquot of the inoculum (0.1 mL) into the same volume of peptone (10mL) as used for the test article to achieve a final concentration of 1.0×1×10^{6.} Serial dilutions were made in DE Neutralizing broth and duplicate pour plates were prepared using SCDA with 0.5% Tween 80 and 0.07% Asolectin. The controls were evaluated for CFU/mL at the beginning of each test.

Recovery Medium Control

One control tube containing a 1/10dilution of Opti-Free® ExpressE Solution was prepared in DE Neutralizing broth (1 mL of the Opti-Free® Express® Solution into 9 mL DE Neutralizing Broth). A second control tube contained 10 mL soybean-casein digest broth (SCDB). The tubes were inoculated with sufficient inoculum of each challenge organism to result in approximately 10-100 CFU of challenge organism per plate. A 1 mL aliquot was plated from each tube in duplicate. Pour plates were prepared using SCDA with 0.5% Tween 80 and 0.07% Asolectin.

Bacterial and yeast control plates were incubated for 2-4 days at 30°-35° C. Mold control plates were incubated for 3-7 days at 20°-25° C.

The recovery obtained in the neutralizer broth (DE Neutralizing Broth) for Opti-Free® Express® Solution was at least 50% of the recovery in the control tube containing SCDB for each challenge organism.

Results

The average log reductions produced by the three test samples of Opti-Free® Express® Solution at the disinfection time of six (6) hours in the presence of 0.0. 0.02. or 0.04 mL organic soil are set forth in the following table:

Summary of Log Reduction at Disinfection Time (6 Hours)

| | SOIL | Average Log Reduction ± SD^{a} | | |
|---|---|---|---|---|
| | LEVEL | Avg. | SD | N |
| S. aureus ATCC 6538 | 0.0 mL | 3.3 | ±0.6 | 16 |
| | 0.02 mL | 2.7 | ±0.3 | 3 |
| | 0.04 mL | 2.7 | ±0.4 | 3 |
| P. aeruginosa ATCC 9027 | 0.0 mL | 5.0 | ±0.5 | 14 |
| | 0.02 mL | 5.0 | ±0.1 | 3 |
| | 0.04 mL | 5.0 | ±0.1 | 3 |
| S. marcescens ATCC | 0.0 mL | 3.7 | ±0.3 | 13 |
| 13880 | 0.02 mL | 3.5 | ±0.2 | 3 |
| | 0.04 mL | 3.3 | ±0.3 | 3 |
| C. albicans ATCC 10231 | 0.0 mL | 2.2 | ±0.7 | 16 |
| | 0.02 mL | 2.8 | ±0.7 | 3 |
| | 0.04 mL | 2.0 | ±0.1 | 3 |
| F. solani ATCC 36031 | 0.0 mL | 4.2 | ±0.8 | 9 |
| | 0.02 mL | 2.5 | ±0.4 | 3 |
| | 0.04 mL | 2.3 | ±0.3 | 3 |

The results show that the Opti-Free® Express® Solution meets the primary criteria of the FDA (51OK) and ISO/DIS 14729 guidelines for the Stand Alone test. In the presence of organic soils, the Opti-Free® Express® Solution met the primary criteria against four (4) of the challenge organisms: P. aeruginosa, S. marcescens, C. albicans, and F. solani; and was within the standard deviation range for the Opti-Free® Express® Solution (no soil) against S. aureus.

I/we claim:

1. An improved, simplified process for cleaning and disinfecting contact lenses with a single solution, which comprises the following steps:
(a) rinsing each side of a contact lens for a few seconds with a single, multi-purpose solution;
(b) soaking the lens in the multi-purpose solution for a time sufficient to clean and disinfect the lens;
(c) removing the lens from the multi-purpose solution; and
(d) rinsing each side of the lens for a few seconds with the multi-purpose solution;
wherein the lens is not rubbed as a part of the initial rinsing step.

2. An improved process according to claim 1, wherein the multi-purpose solution comprises a cleaning system, a comfort system and a disinfecting system.

3. An improved process according to claim 2, wherein the multi-purpose solution has the following formula:

| Ingredient | % (w/v) |
|---|---|
| Polyquaternium-1 | 0.001 |
| AMP-95 | 0.45% |
| MAPDA | 0.0005% |
| Boric acid | 0.6 |
| Sorbitol | 1.2 |
| Sodium chloride | 0.1 |
| Sodium citrate | 0.65 |
| Tetronic 1304 | 0.05 |
| Disodium Edetate | 0.05 |
| Sodium hydroxide | Q.S. pH 7.8 |
| Hydrochloric acid | Q.S. pH 7.8 |
| Purified water | Q.S. 100. |

4. An improved, simplified process for cleaning and disinfecting contact lenses, which consists essentially of the following steps:
(a) rinsing each side of a contact lens for a few seconds with a single, multi-purpose solution;
(b) soaking the lens in the multi-purpose solution for a time sufficient to clean and disinfect the lens;
(c) removing the lens from the multi-purpose solution; and
(d) rinsing each side of the lens for a few seconds with the multi-purpose solution;
wherein the lens is not rubbed as part of the initial rinsing step.
